(19) United States
(12) Patent Application Publication
(10) Pub. No.: US 2003/0086564 A1
(43) Pub. Date: May 8, 2003

(54) Method and apparatus for cipher encryption and decryption using an s-box

(76) Inventor: Douglas A. Kuhlman, Elgin, IL (US)

Correspondence Address: MOTOROLA, INC., 1303 EAST ALGONQUIN ROAD, IL01/3RD, SCHAUMBURG, IL, 60196

(21) Appl. No.: 09/946,280

(22) Filed: Sep. 5, 2001

(51) Int. Cl. H04K 1/04

(52) U.S. Cl. 380/37

(57) ABSTRACT

A cipher encryption and decryption method and apparatus which uses a plurality of rounds (221). Each round contains a plurality of s-box subrounds (100), a matrix convolution (250) and an XOR with a key. Each s-box subround has a permutation polynomial (430), modulo reduction (435) and a hilo swap (450). Processor efficiency is favored in a forward operation over an inverse operation.

### BACKGROUND OF THE INVENTION

1. Technical Field of the Invention

The present invention relates to a cipher method and apparatus and, more particularly, a method and apparatus for cipher encryption and decryption using a permutation polynomial in an s-box.

2. Description of the Related Art

There is prior art in the generation of block ciphers. Many of the older, common schemes are DES, 3DES, IDEA, Blowfish and SAFER as described in the book Applied Cryptography by Bruce Schneier. Newer schemes include TwoFish, Rijndael (the new AES), Serpent and Mars.

These ciphers are all designed to be general-purpose and to operate efficiently on a wide variety of platforms. What is needed is a tailor-designed cipher that is more optimal on certain platforms.

Known cipher designs rely on look-up tables as a confusion element. This requires a lot of space and can slow an algorithm. Also, known cipher designs do not easily integrate with other cryptographic primitives, such as a stream cipher.

### SUMMARY OF THE INVENTION

A cipher method and apparatus generates a cipher output based on a cipher input in a plurality of rounds. Each round has an s-box comprising a plurality of s-box subrounds. The subrounds permute the contents of the cipher input based on a permutation polynomial and generate a set of least significant places by modulo reduction. Finally in a subround, the set of lest significant places is swapped about itself to produce an s-box subround output. Then, in a round, a matrix convolution takes the s-box output and generates a matrix convolution output. Finally, in a round, an XOR receives the matrix convolution output and performs an XOR operation with a key to generate a round output.

### BRIEF DESCRIPTION OF THE DRAWINGS

These and other shortcomings are addressed by the new cipher design of the present invention which will become more apparent from the following detailed description when read in conjunction with the accompanying drawings.

FIG. 1 illustrates an s-box subround according to the present invention;

FIG. 2 illustrates a block cipher having four rounds;

FIG. 3 illustrates an inverse block cipher having four rounds;

FIG. 4 illustrates the s-box of FIG. 2 having four subrounds;

FIG. 5 illustrates the inverse s-box of FIG. 3 having four subrounds;

FIG. 6 illustrates a hilo swap on the output of the modulo reduction permutation polynomial within the s-box;

FIG. 7 illustrates a table for a four bit example of the calculations within an s-box;

FIG. 8 illustrates a table for a four bit example of the calculations within an inverse s-box;

FIG. 9 illustrates the matrix convolution of a round in the block cipher of FIG. 2;

FIG. 10 illustrates an inverse matrix convolution of a round in the block cipher of FIG. 3; and

FIG. 11 illustrates a stream cipher key implementation for the block cipher of FIGS. 2 and 3.

### DESCRIPTION OF THE PREFERRED EMBODIMENTS

A new cipher technique called the Dynamic Entanglement Cipher Knot (DECK) addresses the above and other problems. The DECK cipher first has a noticeably faster decryption time (on thirty-two bit processors), minimizing processor load, allowing background decryption. Second, the key agility is much higher, allowing for lower start-up times and more frequent re-keying with minimal delay. Third, the new invention has a smaller footprint, requiring less memory to store the executable code and associated tables. Fourth, the new invention requires less memory during execution.

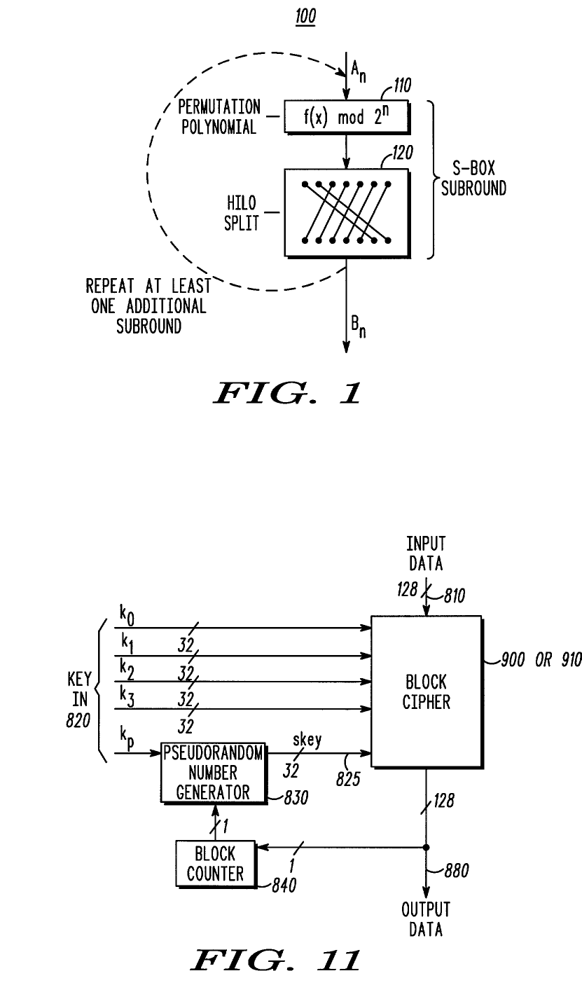

FIG. 1 illustrates an s-box 100 provided within a block or stream cipher of the present invention. Multiple s-box subrounds are performed within the s-box to generate a cipher output Bn from the input An. Each s-box subround contains a permutation polynomial function 110 with modulo reduction and a hilo split 120.

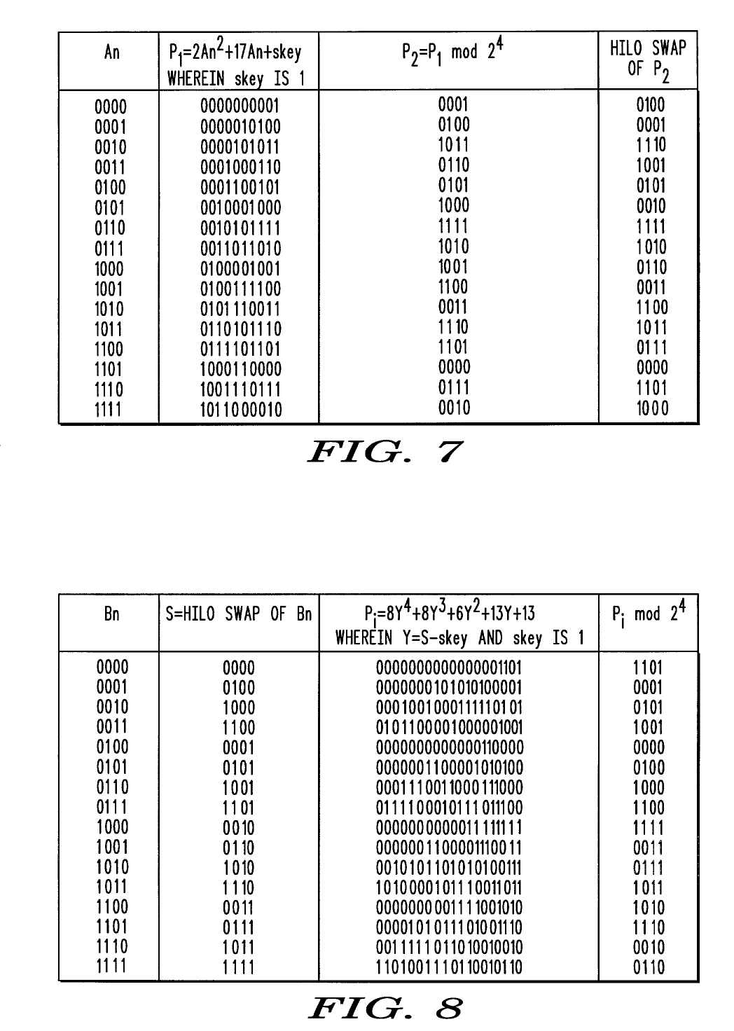

Definitions behind the meaning of a permutation polynomial follow. A polynomial is a mathematical expression of one or more algebraic terms each of which consists of a constant multiplied by one or more variables raised to a integral power (as a+bx+cx²). A permutation is a bijection from a set to itself. Basically, what this means is that a permutation mixes up the order of the elements of a set. A bijection is a mapping which is both one-to-one and onto. A mapping is one-to-one if every image has a unique preimage. That is, no two elements of the set map to the same place. A mapping is onto if every element in the set mapped to has a preimage. That is, everything in the set mapped to has some element in the first set which maps specifically to that element. A preimage is the set before a permutation. Thus, a permutation polynomial on a set is simply a polynomial that is a bijection on the elements of a set S. In our primary case of interest, the set of elements we are operating on is the set of thirty-two bit numbers (the ring Z/2³²Z). The polynomial describes the mapping of elements. The first and last columns of the examples of FIGS. 7 and 8 will illustrate a permutation on a four bit example of the s-box.

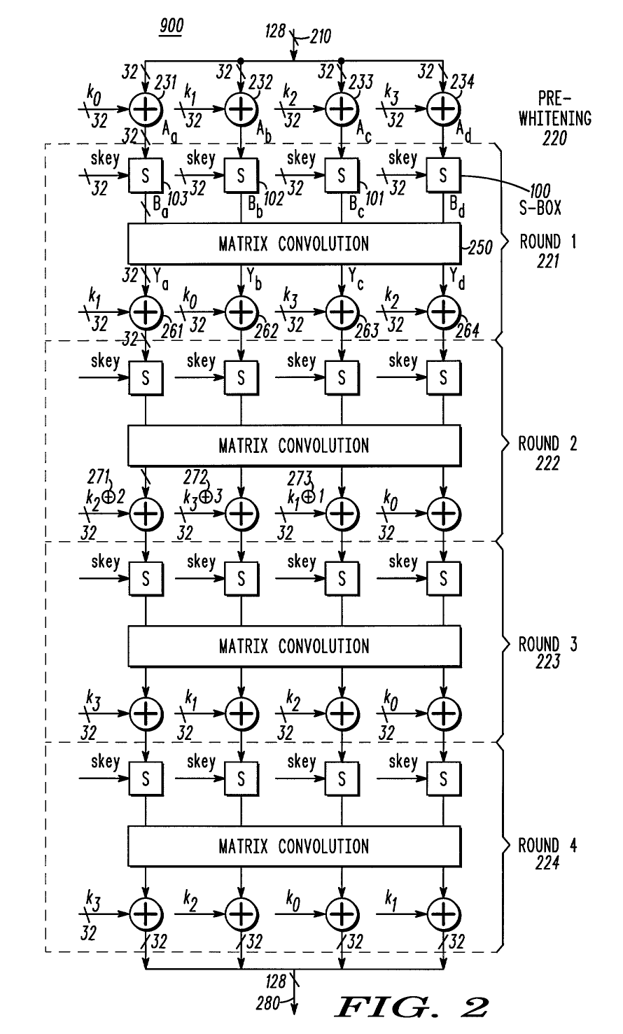

FIG. 2 illustrates a block cipher 900 having four rounds 221, 222, 223 and 224 as in the DECK cipher. According to a preferred embodiment, a processor with a word size width of 32 bits operates on an 128 bit width cipher input 210 according to a key containing keys k0, k1, k2, k3 and containing an skey. The 128 bit wide cipher input 210 is split into four thirty-two bit paths for processing. Each of the four paths is first pre-whitened 220 before the rounds in the block cipher of FIG. 2. The pre-whitening is accomplished by the XOR operations 231, 232, 233 and 234 on each of the four thirty-two bit paths and on a path's corresponding key k0, k1, k2 or k3. The XOR operations are illustrated in FIG. 2 by a large plus sign within a circle. The outputs of the XOR operations 231, 232, 233 and 234 then enter the first round 321.

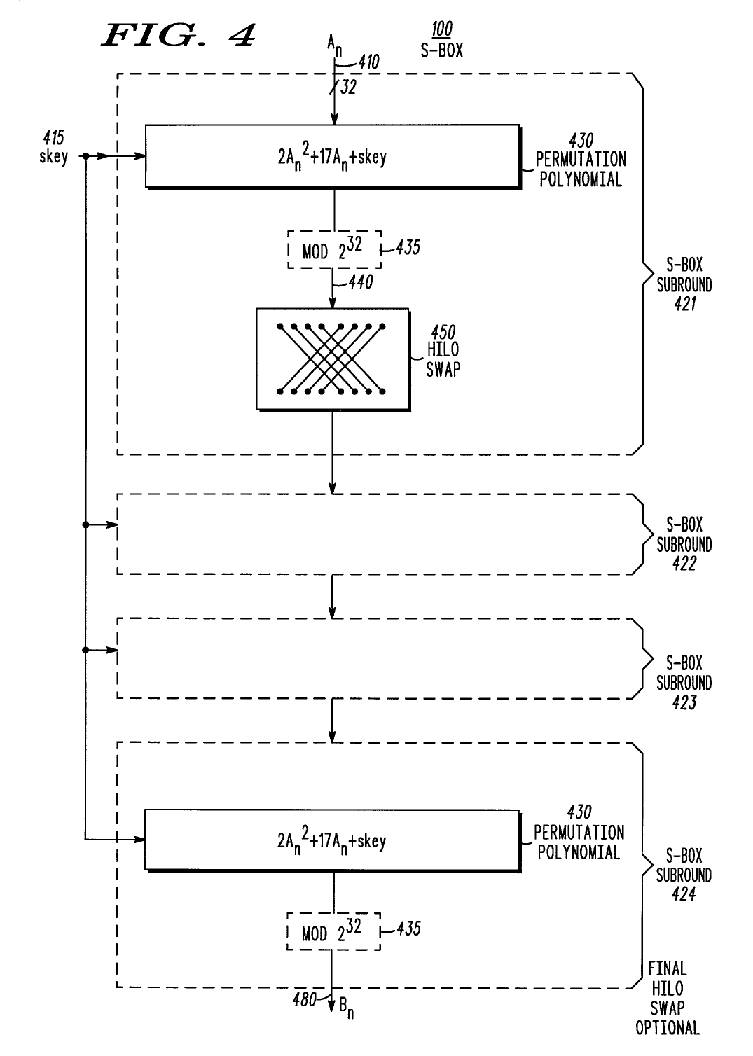

An s-box 103, 102, 101 or 100 is first performed on each input Ad, Ac, Ab and Aa to provide an s-box output Ba, Bb, Bc and Bd for each round 221, 222, 223 and 224. The s-box is illustrated in FIG. 2 by a square labeled with an S. The permutation polynomial with modulo reduction and a hilo split of the s-box operation will be further described below in accordance with FIG. 4.

Continuing with the description of FIG. 2, a matrix convolution 250 is performed on the outputs Ba, Bb, Bc and Bd of all four of the s-boxes 100 to generate Ya, Yb, Yc and Yd. The matrix convolution 250 will further be described below in accordance with FIG. 9. Finally, whitening XOR operations 261, 262, 263 and 264 against the keys are performed on the results Ya, Yb, Yc and Yd of the matrix convolution 250.

At the end of each of the four rounds 221, 222, 223 and 224, the keys k0, k1, k2 or k3 are used in the XOR operations in different orders as illustrated to increase cipher strength. In the second round 222, extra pre-XOR operations 271, 272 and 273 are performed with an arbitrary integer on keys k2, k3 and k1 to further increase strength.

At the end of four rounds 221, 222, 223 and 224, the four thirty-two bit paths are rejoined to provide a 128 bit wide cipher output 280.

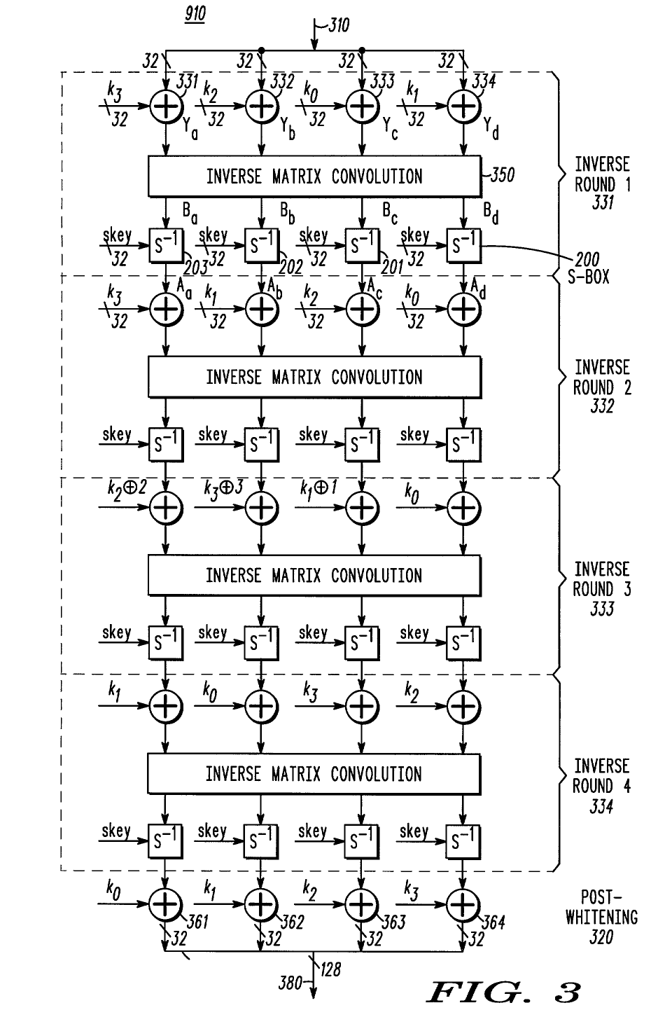

FIG. 3 illustrates an inverse block cipher 910 having four rounds 331, 332, 333 and 334 prior to post whitening 320. The inverse block cipher 910 is similar in construction to the block cipher 900 only reversed for the most part. The inverse block cipher 910 performs a DECK cipher on an input cipher 310 in the inverse direction to produce an output cipher 380.

Each round first performs XOR operations 331,332,333 and 334 prior to an inverse matrix convolution 350. The XOR operations 331, 332, 333 and 334 operate on the divided input cipher 310 and its respective key k3, k2, k0 or k1 as illustrated.

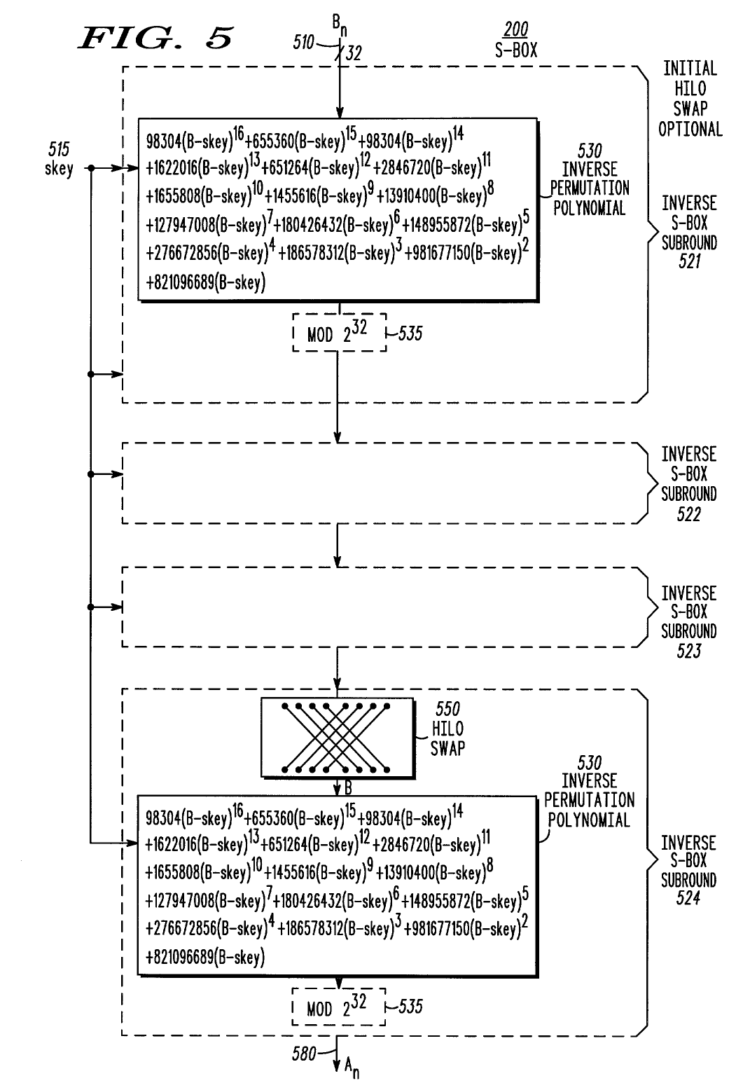

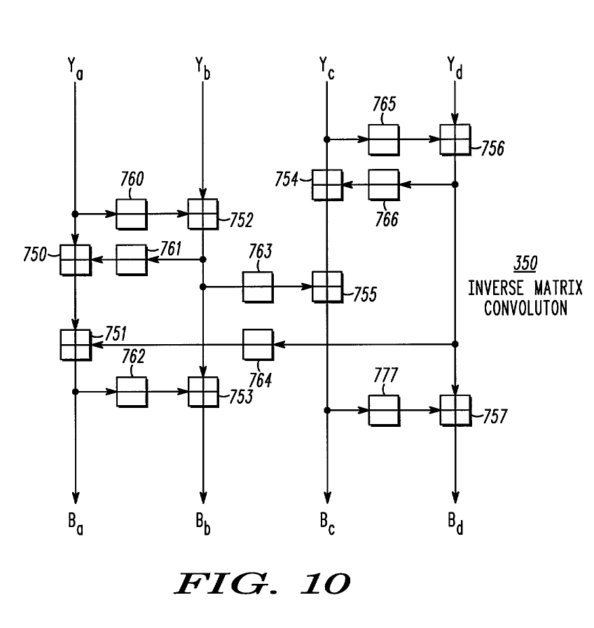

An inverse s-box 203, 202, 201 and 200 operates on a respective output Ba, Bb, Bc or Bd from the inverse matrix convolution 350 using the skey. The inverse s-boxes are illustrated in FIG. 3 by a square labeled with an S⁻¹. The inverse matrix convolution 350 will be further described below in accordance with FIG. 10. The inverse s-box operation including a hilo split and an inverse permutation polynomial with modulo reduction will also be further described below in accordance with FIG. 5.

The block cipher 900 and the inverse block cipher 910 perform reversed operations from one another. Given the same keys, one of these ciphers can be used as a cipher encoder and the other as a cipher decoder. A design aim of the present invention is for the block cipher 900 to have a less mathematically demanding processor load than the inverse block cipher 910. This is advantageous when one cipher has much processing power and current available, such as in a server, while the other cipher has little processing power and battery current, such as in a portable electronic device, e.g., a cellular telephone or the like. Accordingly, because the s-box 100 of the block cipher 900 of FIG. 2 is a relatively simple permutation polynomial, it uses less processing power and current than the relatively complex permutation polynomial of the s-box 200 of the block cipher 910 of FIG. 3. Thus, the less demanding cipher of FIG. 2 would be placed in a portable electronic device such as a cellular telephone and the more demanding inverse cipher of FIG. 3 placed in a server. The FIG. 2 cipher is thus ideal for decoding multimedia content to be played to the user of such a cellular telephone or like low memory and low current device.

After four rounds 331, 332, 333 and 334, the post whitening 320 is performed by XOR operations 361, 362, 363 and 364 with the illustrated keys k1, k2, k3 and k4 to provide four thirty-two bit words which are combined to assemble the 128 bit cipher output 380.

FIG. 4 illustrates the s-box of FIG. 2 having four subrounds 421, 422, 423 and 424. The s-box input 410 is preferably a thirty-two bit wide word An, to match the word size width of the processor. A permutation polynomial 430 takes the s-box input 410 and the skey 415 and derives the permuted output 440 with modulo reduction. In the preferred embodiment, the permutation polynomial is

[2An²+17An+skey] mod 2³²

wherein An is the input cipher.

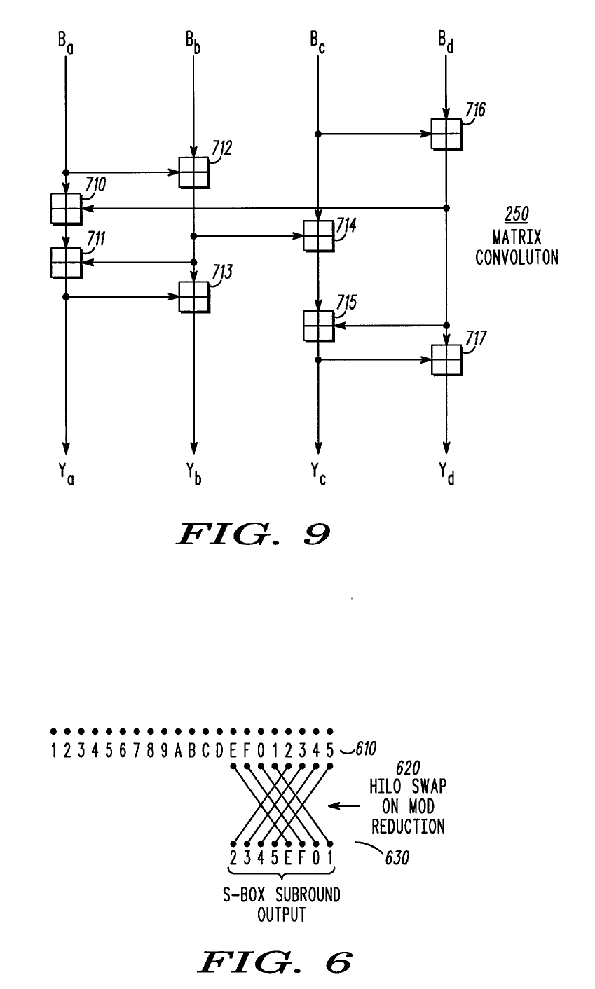

The permutation polynomial 430 provides a modulo reduction by the inherent output selection in a digital computer of the preferred embodiment of the present invention. Modulo reduction block 435 illustrates the mod 2³² operation. Because this modulo reduction is inherent when taken from an output of the permutation polynomial 430, the modulo reduction 435 is illustrated in the figures by phantom lines. The modulo reduction will be further described by the below illustration of FIG. 6. A hilo swap 450 is the final operation in the s-box subround of FIG. 4. The hilo swap 450 splits the thirty-two bits of the preferred embodiment into two sixteen bit parts and moves the upper half to the lower side and moves the lower half to the upper side as illustrated.

Permutation polynomials with modulo reduction are by themselves susceptible to cryptanalysis attacks to derive the key. Thus the permutation polynomial is placed, among other things, in a series of s-box subrounds to avoid such attacks. A minimum of four subrounds has been found to be most secure for thirty-two bit words. A hilo swap 450 is added in each subround either before or after the permutation polynomial, as long as the inverse is the opposite. Additionally, a hilo split is unnecessary on the last subround if done at the bottom or on the first subround if done at the top because it does not add to cipher strength. Nevertheless, it has been found to be computationally faster for a processor when the final s-box round 424 contains a final hilo swap 450.

The selection of the skey can be arbitrarily chosen. Because it is simply an additive constant in the preferred embodiment, the skey itself can be zero. Nevertheless, most skey values other then zero provide some additional strength when used. While any skey is possibly valuable, the primary addition to cryptographic strength occurs when the skey is unknown to the attacker.

Although four subrounds are preferred in the thirty-two bit word size width processor of FIGS. 4 and 5, any plural number of subrounds can provide a secure cipher having processing efficiencies, particularly with a simple permutation polynomial on one end and a more complex permutation polynomial on the other.

The final s-box subround 424 does not need a final hilo swap before generation of the cipher output Bn 480. Nevertheless, as was described above with FIG. 4, it has been discovered that when multiple s-box subrounds are implemented in a processor, the microprocessor operates more efficiently when all four subrounds are identical and a final hilo swap is also performed in the final s-box subround 424.

The multi-subround s-box is preferably implemented in a processor by sequentially implemented equations as illustrated in the drawings. It is possible to implement them in a single look-up table. However, a look-up table to implement a robust version of the present invention would require an unrealistically large size table given today's computing capabilities. The example of the preferred embodiment of four s-box subrounds requires 16 gigabytes as a look-up table on any processor. Sequential implementation of the s-box equations for a four subround s-box on a thirty-two bit MCORE 330 processor requires 64 bytes of code and 48 processor cycles.

The s-box 100 of FIG. 4 consists of a series of four (permutation) polynomials and hilo swaps (of sixteen bits). The swaps exchange the high and low sixteen bits of the thirty-two bit word. The following psuedocode, written in C, shows how it would be implemented.

unsigned long FUNC(unsigned long x, unsigned long skey){
/* FUNC returns the value 2x² + 17x + skey, which can vary. */

unsigned long result;
result=2*x*x + 17 * x + skey;
return result;

}
unsigned long S(unsigned long x, unsigned long skey) {

unsigned long temp_1, temp_2=x;

int i;

for (i=0; i<=3; i++) {

temp_1 = FUNC( temp_2, skey);
temp_2=(temp_1<<16)|(temp_1<<16);

/* This swaps the high and low 16 bits */

}

/* Repeated four times */

return temp_2;

}

FIG. 5 illustrates the inverse s-box of FIG. 3 having four subrounds. A thirty-two bit wide input Bn 510 is input to the four inverse s-box subrounds 521, 522, 523 and 524. In each inverse subround, an inverse permutation polynomial 530 combines its input with an skey 515. The output 537 of the inverse permutation polynomial 530 is taken by modulo reduction 535. For the preferred embodiment of a thirty-two bit processor with a thirty-two bit s-box, a mod 2³² operation makes the least significant thirty-two bits available to the next inverse subround. Because this modulo reduction is inherent when taken for any output of the permutation polynomial, the module reduction 535 is illustrated in the figures by phantom lines.

The inverse permutation polynomial of each inverse s-box subround in the preferred embodiment is

| | |
|---|---|
| [98304(B-skey)¹⁶+ | 65 5360(B-skey)¹⁵+ |
| 98304(B-skey)¹⁴+ | 162 2016(B-skey)¹³+ |
| 651264(B-skey)¹²+ | 28 46720(B-skey)¹¹+ |
| 1655808(B-skey)¹⁰+ | 1 455616(B-skey)⁹+ |
| 13910400(B-skey)⁸+ | 127947008(B-skey)⁷+ |
| 180426432(B-skey)⁶+ | 148955872(B-skey)⁵+ |
| 276672856(B-skey)⁴+ | 186578312(B-skey)³+ |
| 981677150(B-skey)²+ | 821096689(B-skey)] |
| mod 2³² | |

wherein B equals the input cipher. As described above with respect to FIG. 4, the input to each inverse s-box subround 521, 522, 523 and 524 can contain a hilo swap 550 prior to the inverse permutation polynomial 530. Nevertheless, it has been discovered that the hilo swap 550 is unnecessary in the first inverse s-box subround 521. It has been discovered, however, that including the hilo swap in all of the inverse s-box subrounds is more efficient, perhaps due to processor programming characteristics.

Since every permutation polynomial is a bijection, an inverse map exists. The inverse map can be expressed as a polynomial, although the composition of the two polynomials will not be the identity polynomial in general. A psuedo-inverse of a permutation polynomial P is defined as any polynomial Q such that Q(P(x))=P(Q(x))=x for any x in the ring. Finding this inverse map is not always trivial and can often be very difficult. In particular, the RSA algorithm depends on the difficulty of finding such an inverse polynomial over the ring Z/(nZ), where n is the product of two large primes.

Our rings of interest are Z/(2ⁿZ), where finding this inverse is reasonably simple. In particular, we can use the ideas of Pohlig and Hellman to find an inverse mod 2 and then successively find an inverse mod 2^{m} for m going from 2 to n. We choose n to match the word size width of the processor. This is slower, in general, than merely evaluating a polynomial. In fact, it requires n evaluations of the polynomial P. This is demonstrated below in Method One.

To invert the s-box of FIG. 4, two possibilities are produced for FIG. 5. The below psuedocode demonstrates two possibilities. The first shows the method more clearly, but the second is faster.

### Method One

unsigned long INVF(unsigned long y, unsigned long skey) {
/* Compute the inverse of FUNC of a number i.e. x such that
FUNC(x)=y */

int i;
unsigned long x=0,number;
for (i=1;i<=32;i++) {

number=FUNC (x, skey);
if((number mod 2\hat{ }i)) != (y mod 2\hat{ }i))

/* 2\hat{ }i means 2 raised to the i^{th} power */

x=x + 2\hat{ }(i-1);

}
return x;

}
unsigned long INVPI (unsigned long x, unsigned long skey) {

int i;
unsigned long temp_1, temp_2;
temp_1=x;
for(i=0;i<4;i++) {

temp_2=(temp_1<<16); | (temp_1>>16);

/* Swap high and low 16 bits of x */

temp_1 = INVF(temp_2,skey);

}
return temp_1;

}
Method Two:

unsigned long INVF2 (unsigned long y, unsigned long skey)
{
/* Compute the inverse of F of a number i.e. x such that F(x)=y */
unsigned long x;
y -= skey;
x = 98304*y\hat{ }16 + 655360*y\hat{ }15 +

98304*y\hat{ }14 + 1622016*y\hat{ }13 + 651264*y\hat{ }12 +
2846720*y\hat{ }11 + 1655808*y\hat{ }10 +
1455616*y\hat{ }9 + 13910400*y\hat{ }8 + 127947008*y\hat{ }7 +
180426432*y\hat{ }6 + 148955872*y\hat{ }5 +
276672856*y\hat{ }4 + 186578312*y\hat{ }3 + 981677150*y\hat{ }2 +
821096689*y;

/* y\hat{ }i means y raised to the i^{th} power
return x;
}
unsigned long INVPI2 (unsigned long x, unsigned long skey) {

int i;
unsigned long temp_1, temp_2;
temp_1=x;
for(i=0;i<4;i++) {

temp_2=(temp_1<<16)|(temp_1>>16);

/* Swap high and low 16 bits of x */

temp_1 = INVF2(temp_2,skey);

}
return temp_1;

}

Method Two simply evaluates one polynomial, instead of finding each inverse bit-by-bit as does the first method. Method Two is the preferred method. skey A truly invertible, very easy to calculate, easily re-keyable 32-32 s-box with no tables has been invented. In a radical departure from look-up tables, algebraic and non-algebraic operations are mixed to create a secure s-box that can be calculated using only shifts, multiplies, and adds.

The general idea can easily be extended to larger/smaller s-boxes. Thirty-two bits is chosen for this example, because most current processors perform arithmetic very efficiently on thirty-two bits and not as efficiently on other sizes. The general principle of this invention remains the same for any size, however.

FIG. 6 illustrates a hilo swap on the output of the modulo reduction permutation polynomial within the s-box of FIG. 4. The output of the permutation polynomial equation is illustrated in hexadecimal format 610. The illustrated example shows the large hexadecimal number 123456789ABCDEF012345. A modulo reduction of 2³² takes the thirty-two least significant bits of this large number 610. The hexadecimal number EF012345 is provided to the hilo swap 620 to provide 2345EF01 as the s-box subround output 630. Such modulo reduction meaningfully reduces cipher processing time while the permutation polynomial and swaps combined with the multiple s-box subrounds of the present invention provides robust cryptography in the block cipher or stream cipher arrangements of the present invention.

To comprehensively show a thirty-two bit polynomial example would require tables with more than four billion rows. Thus, only four bits are used in the following example s-box and inverse s-box calculations of FIGS. 7 and 8. Recall that thirty-two was chosen to match the word size width of the processor.

FIG. 7 illustrates a four bit example of the calculations within an s-box. A four bit s-box input An is illustrated in the first column of FIG. 7 with all sixteen binary numbers zero to fifteen. The result of the permutation polynomial is illustrated by the ten bit wide numbers in the second column of FIG. 7 having an output P_{I} from the permutation polynomial based on the s-box input An and the skey. The thirty-two bit polynomial inputs to the s-box in the preferred embodiment would result in a second column binary number output widths of as large as a 65 binary places. A modulo reduction taking the four least significant places is illustrated in the third column of FIG. 7. This is equivalent to taking the result mod 2⁴. Finally a hilo swap of this result is illustrated in the fourth column of FIG. 7 and represents the output of a subround of an s-box. Of course, for a final s-box, as described above, the hilo swap is unneeded but may be used anyway for processor programming efficiencies. It can thus be readily seen by comparing the first and fourth columns of the table in FIGS. 7 or 8 that the sets of four bit binary numbers are permutations.

FIG. 8 illustrates a four bit example of the calculations within an inverse s-box. An exemplary four bit inverse s-box input Bn is illustrated in the first column of FIG. 7 with all sixteen binary numbers zero to fifteen. The second column of FIG. 8 illustrates a hilo swap of the input. The third column of FIG. 8 illustrates the result of the inverse permutation polynomial. The inverse permutation polynomial of the four bit example of FIG. 7 and 8 is simpler than thirty two bit permutation polynomial illustrated in FIG. 5 as described above. In example of FIG. 8, the inverse permutation polynomial is simply Pᵢ=8Y⁴+8Y³+6Y²+13Y+13 wherein Y is hilo swap of the s-box input minus the skey. The result of the inverse permutation polynomial is illustrated by the nineteen bit wide binary numbers in the third column of FIG. 8. The thirty-two bit polynomial inputs to the inverse s-box in the preferred embodiment would result in a second column binary number output widths of as large as a few thousand binary places. By performing the modulo reduction on such very wide numbers, a thirty-two bit number matching the width of a processor is created. This makes processor efficiencies realizable. The fourth column of FIG. 8 illustrates such modulo reduction by taking the four least significant places.

When comparing FIGS. 7 and 8, it is important to note that they are truly inverses of each other. That is, trace any entry in any row in the first column to find its output value in the fourth column of FIG. 7. Use this as an input value of the first column in FIG. 8 and trace to the fourth column of FIG. 8. This will match the original value in the first column of FIG. 7. Similarly, one can trace a value in the first column of FIG. 8 and use that as an input to the first column of FIG. 7 to find the original starting value.

FIG. 9 illustrates the matrix convolution 250 of a round in the block cipher of FIG. 2. Thirty-two bit wide inputs Ba, Bb, Bc and Bd are processed by a matrix convolution to derive thirty-two bit wide outputs Ya, Yb, Yc and Yd. The algebraic matrix calculations can simply be implemented by the modulo addition operations 710, 711, 712, 713, 714, 715, 716 and 717 of arranged as illustrated in FIG. 9. Each of the modulo addition operations 710, 711, 712, 713, 714, 715, 716 and 717 is illustrated by a square with a plus sign and represents a mathematical addition followed by mod 2³².

Multiply the input values Ba, Bb, Bc and Bd by the following matrix M is equivalent to the additions of FIG. 9. Thus, this matrix is the preferred embodiment of the cipher, although not necessarily the preferred method of implementation.

$$M = [ \begin{matrix}2 & 1 & 1 & 1 \\ 3 & 2 & 1 & 1 \\ 1 & 1 & 2 & 1 \\ 1 & 1 & 3 & 2\end{matrix} ]$$

For further clarification, equivalent psuedocode to do the matrix convolution is

B_{d}+=B_{c}; B_{b}+=Bₐ; Bₐ+=B_{d}; B_{c}+=B_{b}; Yₐ=Bₐ+B_{b}; Y_{b}=Y_{b}+Bₐ; Y_{c}=B_{c}+B_{d}; Y_{d}=B_{d}+Y_{c};

FIG. 10 illustrates an inverse matrix convolution 350 of a round in the block cipher of FIG. 3. Thirty-two bit wide inputs Ya, Yb, Yc and Yd are processed by an inverse matrix convolution to derive thirty-two bit outputs wide outputs Ba, Bb, Bc and Bd. The algebraic matrix calculations can simply be implemented as arranged in FIG. 10 by the modulo addition operations 750, 751, 752, 753, 754, 755, 756 and 757 and the modulo sign change operations 760, 761, 762, 763, 764, 765, 766 and 777. Each of the modulo addition operations 750, 751, 752, 753, 754, 755, 756 and 757 is illustrated by a square with a plus sign and represents a mathematical addition followed by mod 2³². Each of the modulo sign change operations 760, 761, 762, 763, 764, 765, 766 and 777 is illustrated by a square with a minus sign and represents a sign change followed by mod 2³². A sign change is the same as an additive inverse.

Again, this sequence of operations can be viewed as a simple matrix multiplication. The inverse matrix M⁻¹ is given below. This matrix is equivalent to the operations in FIG. 10 and is thus the preferred embodiment.

$${M}^{- 1} = [ \begin{matrix}2 & - 1 & 1 & - 1 \\ - 3 & 2 & - 1 & 1 \\ 1 & - 1 & 2 & - 1 \\ - 1 & 1 & - 3 & 2\end{matrix} ]$$

Different kinds of matrix convolutions can be used and the above matrix convolution and inverse matrix convolution is an example of the preferred embodiment. However, it is understood to be important for security that the matrix convolution is a matrix convolution that is invertible, has no zero entries, has at least three odd entries in each row and column and the inverse of such matrix convolution also is invertible, has no zero entries, has at least three odd entries in each row and column.

The purpose of the matrix is to cause diffusion of all plaintext/ciphertext and key data as fast as possible, while still keeping speed high. The general method is to set the output to be a linear combination of all of the input.

The purpose behind having no zero entries is to make each of the four input values influence all four output paths. This serves to make differential cryptanalysis significantly more difficult. An even entry in the matrix means that not every place of one path actually modifies the other. To maximize diffusion (and to prevent specific types of differential analysis), these have to be limited. It is impossible to have no even entries in the matrix, as any matrix with only odd entries will have an even determinant and will therefore not be invertible. All of the operations are done mod 2³².

FIG. 11 illustrates a stream cipher key implementation for the block cipher of FIGS. 2 and 3 based on a key input 820. FIGS. 2 and 3 illustrate respective block and inverse block ciphers 900 or 910. A block cipher has a constant key. In certain applications, a change in key is possible using a stream cipher arrangements as illustrated in FIG. 11.

The skey is preferably the same for the operation of all of the s-boxes. However, to add complexity and perhaps improve security, the skey can be varied internally by minor perturbations in one or more of the rounds. Consider changing all of the skeys after a certain number of 128 bit blocks. This provides robustness against certain replay attacks.

Any cryptographically strong pseudo random number generator could be used to create the skey(s) for the s-boxes. A pseudo random number generator is a deterministic process that produces random looking numbers. A pseudo random number generator will produce the same sequence when initialized with the same key. The psuedo random number generator generates the skey in response to a key every given number of new 128 bit blocks. An alternative to counting the blocks output from the rounds, would be to count the blocks output from the subrounds. Even though it is generally easier to implement the counting of blocks from a round, the counting of blocks from a subround would yield as secure of a cipher.

In a stream cipher of FIG. 11, the skey 825 changes based on a number generated in a pseudorandom number generator 830. A pseudorandom number generator 830 generates a different skey number 825 based on an input kₚ and a trigger from a block counter 840. The block counter 840 counts a number of cipher block output from the block cipher 900 or 910 and generates the trigger after predetermined number of blocks have been outputted as output 880 from the block cipher 900 or 910.

The present invention performs some of the same functionality as existing methods, but it is an improvement in four ways:

1. Faster decrypt time

2. Faster key initialization

3. Less program/table space

4. Less RAM required while running

The following Table 1 summarizes many of the important improvements of the 128 bit block DECK cipher of present invention, by comparison with some of the current, widely-used block ciphers:

TABLE 1
Comparison with Other Ciphers

| Operation | DES | DES2 | 3DES | DECK | RC5 | AES |
|---|---|---|---|---|---|---|
| Key init | 149 us | 295 us | 441 us | 2 us | 217 us | 220** us |
| Encrypt | 92 us | 248 us | 248 us | 338 us | 34 us | 104 us |
| Decrypt | 92 us | 248 us | 248 us | 55 us | 36 us | 101 us |
| Prog Size | 14092 | 14092 | 14092 | 2272 | 3880 | 4732 |
| Tables | 5008 | 5008 | 5008 | 0 | 4 | 13040 |
| RAM* | 352 | 352 | 352 | 85 | 370 | 436 |

*approximate
**AES has two key schedules, one for decrypt, and one for encrypt. The time given is the sum of both.

All times were found using an MCORE simulator and assume a 16 MHz clock and are given in microseconds (millionths of a second). It should be noted that DES, DES2, 3 DES, and RC5 all operate on 64 bits, while DECK and AES operate on 128-bit blocks.

For many current schemes, key setup, where the key is manipulated in a way almost as complex as the input, takes a reasonably significant amount of time. The ease with which one key can be replaced with another key is called key agility. It is an important feature in general and especially so when multiple keys are going to be used on one file.

The DECK cipher has supreme key agility. The key set-up phase is practically non-existent. The DECK cipher can afford this somewhat cavalier attitude toward key set-up because of the diffusive power of the matrix multiply and the large mixing nature of the s-box. Changing a key requires no additional time, which is quite a change from most block ciphers in the world today. Rekeying the s-box is also a very fast operation. By using the inverse polynomial g(x) given above, we can re-key the s-box with basically no loss in time.

Although the invention has been described and illustrated in the above description and drawings, it is understood that this description is by example only and that numerous changes and modifications can be made by those skilled in the art without departing from the true spirit and scope of the invention. Assuming enough memory is available, lookup tables are possible, even today. However, the size of the lookup table for a thirty-bit word would require 16 gigabytes. Even should such tables become practical in the future, it is expected that the time required to access an individual entry might exceed that to calculate it via the polynomial. Regardless, to calculate the entries in the table, an individual would have to use the methods described in this invention.

what is claimed is:

1. A cipher apparatus comprising an s-box for generating a cipher output based on a cipher input, the s-box comprising a circuit for:
permuting the contents of the cipher input based on a permutation polynomial and generating a set of least significant elements by modulo reduction; and
swapping the set about itself to produce the cipher output.

2. A cipher apparatus according to claim 1, wherein the s-box includes a plurality of s-box subrounds.

3. A cipher apparatus according to claim 2, wherein a final of the plurality of s-box subrounds avoids the swapping.

4. A cipher apparatus according to claim 1,
wherein the cipher apparatus obtains a key to be used for generation of the cipher output from the cipher input; and
wherein the permutation polynomial has an skey term that is based on the key.

5. A cipher apparatus according to claim 2,
wherein the permutation polynomial consists essentially of
[2A²+17A+skey] mod 2ⁿ
wherein A is the input cipher and n corresponds to a word size width of the processor.

6. A cipher apparatus according to claim 1,
wherein a size of the set of least significant elements for modulo reduction corresponds to the word size width of the processor.

7. A cipher apparatus according to claim 2, wherein the swapping of the set about itself to produce the cipher output performs a hilo split operation on the set of elements.

8. A cipher apparatus according to claim 2, wherein the cipher apparatus comprises a plurality of rounds, each round comprising:
the s-box comprising a plurality of s-box subrounds to operate on the cipher input and generate an s-box output;
a matrix convolution operatively connected to a last s-box subround to receive the s-box output and generate a matrix convolution output; and
an XOR operatively coupled to the matrix convolution to receive the matrix convolution and perform an XOR operation with a key to generate the cipher output.

9. A cipher apparatus according to claim 8,
wherein the cipher apparatus obtains an skey to be used by the subrounds for generation of the cipher output from the cipher input; and
wherein the cipher apparatus further comprises a block counter operatively connected to count a number of blocks output and modify the skey in a predetermined pattern after a predetermined number of blocks.

10. A cipher apparatus according to claim 2, wherein the circuit is implemented in a processor.

11. A cipher apparatus for generating a cipher output based on a cipher input comprising:
a plurality of rounds, each round comprising:
an s-box comprising a plurality of s-box subrounds to operate on the cipher input and generate an s-box output, the subrounds comprising a circuit for
permuting the contents of the cipher input based on a permutation polynomial and generating a set of least significant places by modulo reduction; and
swapping the set about itself to produce an s-box subround output;
a matrix convolution operatively connected to a last s-box subround to receive the s-box output and generate a matrix convolution output; and
an XOR operatively coupled to the matrix convolution to receive the matrix convolution output and perform an XOR operation with a key to generate a round output.

12. A cipher method of creating a cipher output from a cipher input, comprising:
(a) permuting the contents of the cipher input based on a permutation polynomial and generating a set of least significant elements by modulo reduction; and
(b) swapping the set about itself to produce the cipher output.

13. A cipher method according to claim 12, wherein said steps (a) and (b) make a subround and a plurality of subrounds are performed to generate the cipher output from the cipher input.

14. A cipher method according to claim 13, wherein a final of the plurality of inverse s-box subrounds avoids a swapping step.

15. A cipher method according to claim 12,
wherein the method further comprising the step of obtaining a key to be used in generation of the cipher output from the cipher input; and
wherein the permuting of step (a) is based on a permutation polynomial having a term and wherein the term is based on the key.

16. A cipher method according to claim 15,
wherein the permutation polynomial has an skey term; and
wherein the skey is based on the key.

17. A cipher method according to claim 16,
wherein the permutation polynomial is
(2A²+17A+skey) mod 2ⁿ
wherein A is the input cipher and n corresponds to a word size width of the processor.

18. A cipher method according to claim 12,
wherein the modulo reduction takes the n least significant elements; and
wherein the number n corresponds to a word size width of the processor.

19. A cipher method according to claim 12, wherein the swapping of the set about itself to produce the cipher output performs a hilo split operation on the set elements.

20. A cipher method according to claim 12, comprising a plurality of rounds, each round comprising the steps of:
(1) performing a plurality of s-box subrounds by performing the s-box method steps (a) and (b) a plurality of times based on the cipher input to generate an s-box output;
(2) performing a matrix convolution on the s-box output to generate a matrix convolution output; and
(3) performing an XOR operation between the matrix convolution output and a key to generate the cipher output.

21. A cipher method according to claim 20, wherein the matrix convolution step (2) is a matrix convolution that is invertible, has no zero entries, has at least three odd entries in each row and column and the inverse of such matrix convolution also is invertible, has no zero entries, has at least three odd entries in each row and column.

22. A cipher method according to claim 20, wherein at least one round further comprises:
a key perturbation XOR operation between the key and an integer to produce a perturbated key.

23. A cipher method according to claim 13, further comprising the steps of
obtaining an skey to be used for generation of the cipher output from the cipher input; and
counting a number of blocks output and modifying the skey in a predetermined pattern after a predetermined number of subrounds.

24. An inverse cipher apparatus comprising an inverse s-box for generating a cipher output based on a cipher input, the inverse s-box comprising a circuit for:
swapping the cipher input about itself to produce a swapped cipher; and
permuting the contents of the swapped cipher based on an inverse permutation polynomial and generating the cipher output by modulo reduction to produce a set of least significant elements.

25. An inverse cipher apparatus according to claim 24, wherein the inverse s-box includes a plurality of inverse s-box subrounds.

26. An inverse cipher apparatus according to claim 25, wherein the inverse cipher apparatus comprises a plurality of inverse rounds, each inverse round comprising:
an XOR to perform an XOR operation between the cipher input and a key to generate an XOR output;
an inverse matrix convolution operatively connected to the XOR to receive the XOR output and generate an inverse matrix convolution output; and
the inverse s-box comprising a plurality of inverse s-box subrounds and operatively connected to the inverse matrix convolution for operating on the inverse matrix convolution output to generate the cipher output.

27. An inverse cipher apparatus according to claim 25, wherein the circuit is implemented in a processor.

28. An inverse cipher apparatus for generating a cipher output based on a cipher input, comprising:
a plurality of inverse rounds, each inverse round comprising:
an XOR to perform an XOR operation between the cipher input and a key to generate an XOR output;
an inverse matrix convolution operatively connected to the XOR to receive the XOR output and generate an inverse matrix convolution output; and
an inverse s-box comprising a plurality of inverse s-box subrounds and operatively connected to the inverse matrix convolution for operating on the inverse matrix convolution output to generate the cipher output, each inverse s-box subround comprising a binary processor for
swapping an s-box input about itself to produce a swapped cipher; and
permuting the contents of the swapped cipher based on a permutation polynomial and generate an inverse s-box subround output by modulo reduction to produce a set of least significant places.

29. An inverse cipher method of creating a cipher output from a cipher input, comprising an s-box method comprising the steps of:
(a) swapping the cipher input about itself to produce a swapped cipher; and
(b) permuting the contents of the swapped cipher based on an inverse permutation polynomial and generating the cipher output by modulo reduction to produce a set of least significant elements.

30. An inverse cipher method according to claim 29, wherein said steps (a) and (b) make a subround and a plurality of subrounds are performed to generate the cipher output from the cipher input.

31. An inverse cipher method according to claim 30, wherein an initial of the plurality of inverse s-box subrounds avoids the swapping step.

32. An inverse cipher method according to claim 29,
wherein the inverse cipher apparatus obtains a key to be used for generation of the cipher output from the cipher input; and
wherein the inverse permutation polynomial has an skey term that is based on the key.

33. An inverse cipher method according to claim 30,
wherein the inverse permutation polynomial consists essentially of

| | |
|---|---|
| [98304(B-skey)¹⁶+ | 65 5360(B-skey)¹⁵+ |
| 98304(B-skey)¹⁴+ | 162 2016(B-skey)¹³+ |
| 651264(B-skey)¹²+ | 28 46720(B-skey)¹¹+ |
| 1655808(B-skey)¹⁰+ | 1 455616(B-skey)⁹+ |
| 13910400(B-skey)⁸+ | 127947008(B-skey)⁷+ |
| 180426432(B-skey)⁶+ | 148955872(B-skey)⁵+ |
| 276672856(B-skey)⁴+ | 186578312(B-skey)³+ |
| 981677150(B-skey)²+ | 821096689(B-skey)] |
| mod 2ⁿ | |

wherein B equals the input cipher and n corresponds to a word size width of the processor.

34. An inverse cipher method according to claim 29,
wherein a size of the set of least significant elements for modulo reduction corresponds to the word size width of the processor.

35. An inverse cipher method according to claim 30, wherein the swapping of the cipher input about itself to produce the swapped cipher performs a hilo split operation.

36. An inverse cipher method according to claim 30, comprising a plurality of inverse rounds, each inverse round comprising the steps of:
(1) performing an XOR operation between the cipher input and a key to generate an XOR output;
(2) inverse matrix convolution of the XOR output and provide an inverse matrix convolution output; and
(3) performing a plurality of s-box subrounds by performing the s-box method steps (a) and (b) a plurality of times based on the inverse matrix convolution output to generate the cipher output.

37. An inverse cipher method according to claim 36, wherein the inverse matrix convolution step (2) is a matrix convolution that is invertible, has no zero entries, has at least three odd entries in each row and column and the inverse of such matrix convolution also is invertible, has no zero entries, has at least three odd entries in each row and column.

38. An inverse cipher method according to claim 37, wherein at least one inverse round further comprises:
a key perturbation XOR operation between the key and an integer to produce a perturbated key.

39. An inverse cipher method according to claim 36, further comprising the steps of
obtaining an skey to be used for generation of the cipher output from the cipher input; and
counting a number of blocks output and modifying the skey in a predetermined pattern after a predetermined number of blocks.
